(19) United States
(12) Patent Application Publication
(10) Pub. No.: US 2007/0138832 A1
(43) Pub. Date: Jun. 21, 2007

(54) Motor vehicle with an extrinsic force-actuated sliding door and closing state monitoring of a window module

(76) Inventors: Jurgen Kraus, Balve (DE); Carsten Lapschies, Weinstadt-Endersbach (DE); Ralf Gerndorf, Finnentrop (DE)

Correspondence Address: STETINA BRUNDA GARRED & BRUCKER, 75 ENTERPRISE, SUITE 250, ALISO VIEJO, CA, 92656, US

(21) Appl. No.: 11/591,900

(22) Filed: Nov. 2, 2006

(30) Foreign Application Priority Data
Nov. 4, 2005 (DE) 10 2005 053 051

(51) Int. Cl. B60J 5/06

(52) U.S. Cl. 296/155

(57) ABSTRACT

The possibility of extrinsic force-actuated opening and closing sliding doors and windows of a motor vehicle, in particular by electric motors, is of known art. Also systems are applied that interrupt or reverse the closing movement of a sliding door or a window if too great a resistance opposes the extrinsic force-actuated movement. Thus in particular the trapping of extrinsic objects is detected and injuries or damage to objects are prevented. With a combination of sliding doors and windows that can open it is, however, also possible that extrinsic bodies protruding through an open window into the traversing range of the sliding door are caught by the sliding door movement. In order to minimise the risk of injuries or damage to objects it is proposed to register the closing and/or opening state of the window before and/or during the opening of the sliding door, and, depending upon the registered closing state or of the window, to permit, delay, prevent or intervene in the opening or closing movement of the sliding door.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The invention concerns a motor vehicle with at least one sliding door that can be moved on one side of the vehicle, actuated by an extrinsic force, in which during a complete opening and closing movement travels through a traversing range, and also at least one window module arranged in the sliding door or in the stationary part of the vehicle bodywork, with one window arranged at least partially within or in the immediate vicinity of the traversing range, wherein the vehicle has control means to avoid an unintended trapping of extrinsic objects or body parts.

Such vehicles are of general known art. In particular minivans, SUVs, small buses and small transporters have sliding doors on one or more both sides of the vehicle. Sliding doors lend themselves however also to other classes of vehicles, since they enable easy boarding, and when fully opened free up a large boarding area, and by means of guidance near the bodywork require only a small traversing range near the bodywork for the opening and closing movement.

Normally vehicles that are fitted with sliding doors also have window modules in the sliding door or in the stationary vehicle bodywork in the immediate vicinity of the traversing range. In some of these vehicles the opening and closing of the windows arranged in the window module is also possible. A window module with a window that can be opened and closed comprises at least one movable window glass element as well as means for opening and closing the window module and/or window. For window modules arranged in the sliding door sliding window modules or swivelling window modules are preferably installed.

Similarly of general known art is the possibility of embodying window modules and sliding doors such that the opening and closing movement is actuated by an extrinsic force, that is to say is carried out automatically on request, in particular driven by an electrical motor. In principle, however, hydraulic or pneumatic actuations of the movement events are also conceivable.

For extrinsic force actuated-embodiments care should be taken that an unusual resistance that opposes the movement is detected and the extrinsic force actuation is interrupted and/or the direction of movement is reversed. In these considerations the possible injuries to persons as a result of trapped body parts are of primary concern. Here children as a rule are particularly endangered, since on the one hand they are often not aware of the hazards, and on the other hand have less strength than adults and can be more easily injured. However in the case of trapped objects it is also important that the trapping of an extrinsic object during an opening or closing movement is detected in order to avoid possible damage to the extrinsic object or to the vehicle.

In the case of the motor vehicles cited above, however, only persons or objects trapped within the window module or between sliding door and bodywork are detected. However, if a motor vehicle has both a sliding door and also a window module that can be opened or closed in the sliding door or in a stationary part of the vehicle bodywork and in the immediate vicinity of the traversing range of the sliding door, it can happen that persons or objects for example protrude through an opened window and out of the vehicle into the traversing range of the sliding door. Thus persons or objects can also be trapped between windows and stationary bodywork, if, for example, a shearing point is formed during the opening movement between the sliding door and parts of the stationary bodywork.

Also persons or objects that protrude through an opened window arranged in the immediate vicinity of the traversing range can be caught by exterior areas of the moving sliding door. The same applies also to a window glass element of a tilting or swivelling window that itself protrudes into the traversing range of the sliding door, or, if the window glass element is part of the sliding door, protrudes out of the traversing range such that a collision with stationary parts of the bodywork is possible during the opening or closing of the sliding door.

In the case of extrinsic force-actuated sliding doors it must also be borne in mind that relatively large forces are required for the closing and opening as a result of their weight. A sliding door must also then be able to be moved, and be opened or closed, if the vehicle is standing on a downhill or uphill gradient such that the door must overcome a difference in height. The forces required for this purpose vary significantly, however, according to whether the opening or closing is against, or with, an inclination of the vehicle. As a result of these force differences it is, however, difficult to determine the critical force at which a critical condition is recognised as a result of trapped extrinsic objects.

While a person when manually opening a sliding door has the traversing range of the sliding door in the field of vision and easily detects any extrinsic objects protruding into this traversing range, for extrinsic force-actuated sliding doors it has to be taken into account that an activation of the opening or closing movement can be initiated from positions located at a distance from the sliding door, for example from the driver's seat, or by a general closing command from the central on-board electronics, for example when leaving the vehicle. Often, therefore, the person who initiates the movement of the sliding door is unaware of what exactly is happening in the traversing range of the sliding door.

For extrinsic force-actuated sliding doors with, at the same time, an arrangement of a window in the traversing range of the sliding door, the further problem arises that body parts or extrinsic objects can not only be trapped between door and bodywork, but also trapping at the window edge is possible. While the sliding mechanism of the window itself usually has a sufficient automatic shut-off mechanism, the door drive pushes against the door with significantly higher force, however.

If now the sliding door is moved sufficiently far such that the window overlaps with parts of the bodywork, an extrinsic object can similarly be trapped between the window edge and this bodywork part. In these circumstances, however, it is not the window drive that is responsible for this trapping; rather the critical movement is initiated by the very much stronger door drive. While for trapping of extrinsic objects between door and bodywork the automatic shut-off mechanism is possibly still sufficient to avoid injuries; however, when trapping, for example, a child's hand the window edge presses onto the child's hand with a very much smaller contact area between window and stationary bodywork part.

### BRIEF SUMMARY

The object of the invention is therefore to create a motor vehicle of the type cited above in which the probability of injuries or damage is reduced.

This object is achieved with the invention in that the control means is formed such that it registers the closing and/or opening state of the window and, depending upon the closing state of the window registered, can intervene in the movement of the sliding door by interrupting, reducing, delaying or reversing the extrinsic force in the event of an endangered state, wherein the endangered state is defined in that extrinsic objects or body parts threaten to intrude into the traversing range because of an opening released by a window located at least partially within the traversing range or in the immediate vicinity of the traversing range. A further object of the invention is couched in the provision of a sliding door module for the build of the above-cited motor vehicle as well as in the provision of a method for the safe closing of a sliding door. These two objects are achieved by Claims 17 and 18.

By means of the motor vehicle thus configured means are now made available that allow the opening and closing event of the sliding door to be made dependent on the closing state of the window. Depending upon the monitoring and/or control strategy the opening or closing event can either be totally stopped, delayed or otherwise influenced so that the endangered state with a danger of injuries and/or damage to objects is prevented or at least minimised from the outset.

Particularly advantageous is the delay of the start of movement of the sliding door until a point in time at which all windows in the critical area are completely closed, or at least closed to the extent that there is no longer any risk of injury or damage to objects. It is similarly conceivable to register the exact position of the opened window glass element, and to permit the sliding door movement only up to a position at which a risk of injury or damage to objects is not to be feared. In particular in the case where a plurality of window modules is present a differentiation of the window module positions can also be made such that a different traverse path is allowed for the sliding door according to the window module concerned.

A logical application of the invention furthermore envisages that the closing and opening movements of the sliding door and the windows are coordinated with each other. Thus in a further embodiment of the invention the sliding door can start to move while the closing event for a window is still under way; when reaching the window the door is slowed down or stopped until the traverse path is again free and is then automatically accelerated once again. It is also conceivable that the opening of a window is detected during the opening or closing movement of the sliding door, and the sliding door movement is immediately stopped.

A further advantage of the invention lies in the fact that the equipment features already present in a motor vehicle of the generic kind can be adopted and used for the invention. A significant equipment of the motor vehicle with new components is usually required.

Moreover a motor vehicle according to the invention can now be built with equipment variants that have previously been avoided on motor vehicles of the generic kind (e.g. swivelling or tilting windows that protrude into the traversing range of the sliding door when open).

Here “in the immediate vicinity of the traversing range of the sliding door” means that the window module is arranged near to the traversing range such that an opening of the window enables objects, including the window glass element of the opened window itself, or persons, to protrude through the window into the traversing range of the sliding door.

It can be envisaged that the control means comprise at least one sensor for the registration of the closing and/or opening state of the window. Similarly the control means can comprise at least one sensor for the registration of the closing and/or opening state of the sliding door.

Magnetic switches, microswitches, photo sensors or resistance or induction path sensors, for example, come into consideration as sensors. Ultimately the decision regarding suitable registration of the closing/opening state will be made depending upon sensor arrangement, measurement quantities to be registered, sensor positioning and other factors that normally have to be taken into consideration. Other sensors that are suitable register the rotation of a component, and so permit deductions concerning the movement and position of the windows or sliding door. Such a sensor can, for example, be coupled with the drive shaft of an electric motor serving as a drive unit. The sensor signals are preferably transmitted in a manner of known art, thus preferably via cables or via conventional radio technologies.

It is furthermore important that the control means comprise a control unit for the control of the opening and closing events and for the processing of signals from sensors to register the opening and closing states of the sliding door and the windows. Here, in particular, one can make use of a control unit that is present in the vehicle. A functional expansion is all that is required.

In a further embodiment it can be envisaged that the control means comprise blocking devices that completely or partially prevent the movement of the sliding door. These blocking devices can, for example, be formed such that when a window is open a clearance for extrinsic force actuation of the sliding door can be suppressed electronically by the control unit. Also drive devices (e.g. electric motors, hydraulic or pneumatic rams) that are designed for the extrinsic force-actuated movement of the sliding door can form the blocking device, in which the drive device is mechanically blocked, or is itself called upon to be a blocking device. Thus can be avoided that a sliding door that is not completely open is unintentionally opened further manually than the control would permit as a result of lack of attention or lack of knowledge.

Nevertheless care can be taken to embody the control means such that they permit a manual opening or closing event that is not actuated by an extrinsic force. Also in the event of a failure or a fault in the control means there is a need to ensure that the sliding door can be opened, even if, for example, the blocking means are activated. This is necessary, for example, in the event of hazards such as a fire in the vehicle, to enable a rapid escape route, or to allow access in the event of a rescue as a result of an accident. Also simply to ensure usage of the vehicle that is as derestricted as possible the ability to operate the sliding door manually even in the event of a system failure can be desirable.

The manual operability can be achieved in a particularly simple manner such that the blocking means do not completely block a manual movement but simply make it more difficult. The blocking means can themselves be formed by an electric motor whose internal resistance opposes a manual movement of the sliding door.

In particular if the sliding door movement with opened windows is not to be totally blocked, the control means preferably comprise delay devices that delay a movement of the sliding door until a point in time at which a movement of the sliding door is possible without risk. The delay devices can, for example controlled via the control unit, delay the clearance of the extrinsic force actuation for a period of time until closing of the sliding door has taken place at least up to a point at which the non-hazardous opening or closing of the sliding door is possible.

For operation of the sliding door and the window modules activation means are provided to start the opening or closing event of the windows or the sliding door. These can be formed by conventional actuation switches. By an interaction between the blocking means, the delay means and the activation means it can be achieved that when actuating an activation means the closing states of the window modules and/or of the sliding door are firstly registered via the sensors.

Depending upon closing states registered a decision is then made, according to a control strategy stored in the control unit, whether the requested activation of an opening or closing event is permitted, whether windows, if necessary, are firstly to be closed, or up to which position an opening movement is permitted. If an extrinsic force-actuated opening event for a sliding door is requested, a closing event for the window modules can thus automatically firstly precede this. Here the door handles of the sliding door can also serve as activation means. For example the actuation of the door handle can firstly only set in motion a closing event of the windows, before any movement of the sliding door is initiated. The same sequence is, of course, also possible via remote operation.

Also in order to prevent or to permit an opening of the window with an already open sliding door only so far such that when closing the sliding door no risk of injuries or damage exists, control devices can be provided for the windows. This is because a window that is opened after the sliding door has been opened and that protrudes into the traversing range of the sliding door can easily be overlooked.

For information purposes acoustic or optical signal transducers can be provided that indicate an intervention of the control means into the sliding door movement, or stopping or delaying of the door by the control means. For example a voice can request the closing of the windows and can provide the relevant information that an extrinsic force-actuated opening of the door is only possible if the windows are closed. Or an acoustic signal can sound, for example, while the windows are automatically being closed to provide information concerning the delay of the opening or closing event. Similarly optical signals or optical and acoustic signals can, of course, also be used alongside each other.

The window module can be a sliding window module and/or a raising/lowering window module and/or a tilting window module and/or a swivelling window module. The window module preferably has the sensor for registering the closing and/or opening state of the window in a guide rail for the movable window glass element and/or in a glass element seating of the window module preferably arranged in or on the window frame of the window module. In the case of swivelling or tilting windows the registration of the closing and/or opening state can also be effected via hinge elements whose relative movements or closing states are registered by a sensor.

A particularly simple control and coordination of individual closing and opening events of windows and the sliding door can be achieved if the window module has an extrinsic force-actuated window. In the case of manually actuated windows the registration of the closing state is indeed possible, but not, however, the initiation of an automatic closing event before the closing or opening of the sliding door by means of the control means. Similarly an opening of the windows with an open sliding door could be achieved by mechanical means only; these however are more complex to implement than control and monitoring using electronics. The extrinsic force actuation thereby is effected preferably electrically using electric motors, but can in principle also be achieved pneumatically or hydraulically.

Similarly a window module and also a sliding door module for a motor vehicle according to the invention are seen as pertinent to the invention. The same applies for a method for opening and closing a sliding door of a motor vehicle according to the invention.

The sliding door module thereby comprises at least one window module. The window module comprises at least one window that can be opened and closed, means for carrying out the opening and closing movement of the window, as well as means for registering the closing or opening state of the window. The means for registering the closing and/or opening state of the window are thereby formed by at least one sensor. The window module can be a sliding window module and/or a raising/lowering window module and/or a tilting window module and/or a swivelling window module.

The sensor for registering the closing state of the window is preferably arranged in or on a guide rail of a movable window glass element and/or in a glass element seating of the window module preferably arranged in or on the window frame of the window module. It can however also be arranged in or on hinge elements of the window module, whose movements relative to one another are registered by a sensor and permit deductions concerning the window position.

In the method for closing or opening of an extrinsic force-actuated sliding door of a motor vehicle, which in a complete opening or closing movement travels through a traversing range, the closing state of the window is registered by control means before and/or during the opening for a window module, with a window that can be opened and closed, arranged in the sliding door or in the stationary vehicle bodywork in the immediate vicinity of a traversing range, and depending upon the registered closing state of the window the control means permits, delays, prevents, or intervenes in the opening or closing movement of the sliding door.

In particular after registration of the closing state of the window the opening or closing event of the sliding door can be delayed by the control means for a period of time until the windows, in particular extrinsic force-actuated as a result of initiation by a control device, are completely or at least partially closed.

With regard to the advantages according to the invention provided by the window module and by the method reference is made to the description of a motor vehicle according to the invention.

The general invention concept can also be transferred by analogy to similar areas of a motor vehicle, e.g. a combination of an automatic convertible hood with an embedded sliding roof, or to other types of vehicles such as trains or ships. Also the application of the invention to a sliding door that is not actuated by an extrinsic force is not excluded. Here, for example, blocking devices could block the mechanics of the opening mechanism until the windows are closed.

### BRIEF DESCRIPTION OF THE DRAWINGS

Further features and advantages of the invention ensue from the dependent claims and from the following description of preferred examples of embodiment with the aid of the drawings.

In the drawings:

FIG. 1 shows a schematic representation of a sliding door of a motor vehicle according to the invention in the closed position and

FIG. 2 shows a schematic representation of a sliding door from FIG. 1 between the closed and fully opened position.

### DETAILED DESCRIPTION

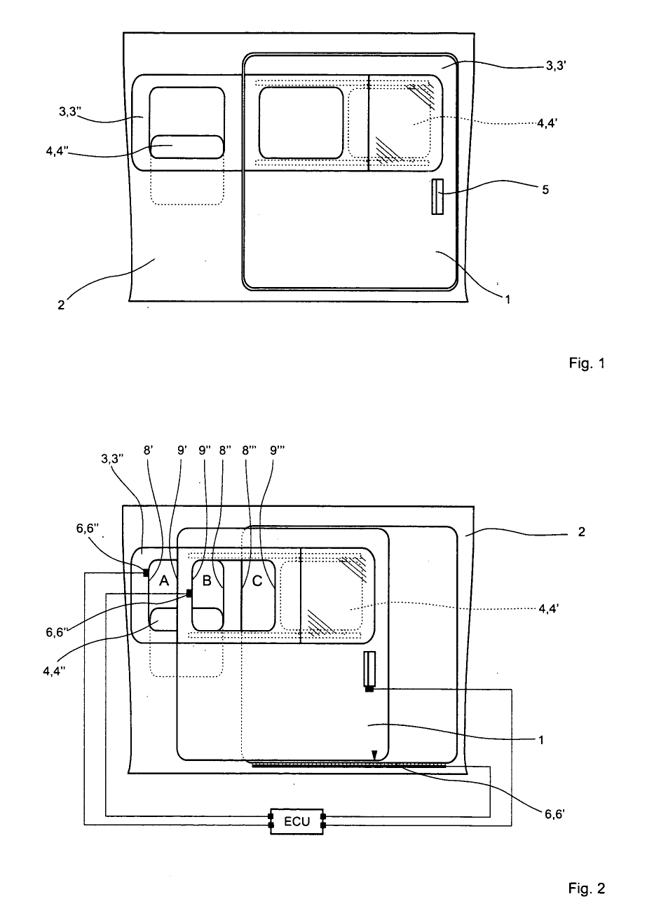

FIG. 1 shows a schematic representation of an extrinsic force-actuated sliding door 1 of a motor vehicle according to the invention in the closed position. The sliding door 1 is arranged within a stationary part of the vehicle bodywork 2 in a manner of known art. Not represented are a drive unit and drive means for actuation of the extrinsic force, which are preferably electrically operated.

In both the stationary bodywork 2 and also the sliding door 1 window modules 3 are arranged with windows 4 that can be opened and closed. In FIG. 1 both windows 4 are shown in an exemplary manner with opened window glass elements. The window modules 3 comprise, in addition to the windows 4, conventional functional elements (guide rails and guide bolts, water management systems, sealing elements, handle elements, drive units for extrinsic force actuation, means for connection with the bodywork etc) for the window modules 3; these elements are not represented.

The window module 3′ arranged in the sliding door 1 comprises in an exemplary manner a sliding window 4′, indicated by the dashed line, which shows a movable window glass element. The window module 3 arranged in the stationary bodywork features a raising/lowering window module 3′, with a window glass element that can be lowered within the bodywork, in a not completely opened position.

The sliding door 1 furthermore has an activation means 5, here in an exemplary manner in the form of a door handle. Such an activation means 5 can, of course, also be formed by another type of switching element. Also its arrangement can be as required, and can be located, for example, on the dashboard, the operating panel, or on another location in the interior of the vehicle or on the exterior of the vehicle.

In FIG. 2 is represented the sliding door 1 of the motor vehicle according to the invention from FIG. 1 in an opened, but not completely opened, position. In contrast to FIG. 1 various sensors 6 are also shown in FIG. 2 in a schematic manner. The sensors 6 can feature any kind of measurement value transducers. According to position, the measurement quantity to be registered, and arrangement, a decision is made concerning a suitable sensor 6. Here the sensor 6″ underneath the lower edge of the sliding door 1 registers in an exemplary manner the exact position of the sliding door 1 in its traversing range.

The sensors 6′, which are arranged in the window modules 3, in particular in guide rails or glass element seatings of the windows 4, simply register whether the window in question is closed or open. It is also possible, of course, to provide sensors 6′ that register the exact window position, or sensors 6″ that establish only whether the sliding door 1 is open. If one simply wishes to makes the sliding door movement dependent on the opening or closing state of the windows 4 or window modules 3, without taking account of the sliding door position itself, and, vice versa, does not wish to make the possibility of opening a window dependent on the opening and closing state of the sliding door, one can, of course, also do without the sensors for registering the opening and closing state of the sliding door 1, or the sensors 6″ for registering the sliding door position.

The signals of the sensors 6 are either permanently, at intermittent intervals, or on request from a central control unit 7 (ECU—Electronic Control Unit) transferred to the latter electrically by cable or using radio technology. If the opening of the sliding door 1 is requested, for example by actuation of the activation means 5, the control unit 7 determines the opening states of the window modules 3 that are located in the immediate vicinity of the traversing range of the sliding door 1.

Depending upon the opening state determined the control unit 7 permits the extrinsic force-actuated movement of the sliding door 1 and initiates this, or blocks and/or delays this. If the window modules 3 themselves possess controllable means for extrinsic force-actuated opening and closing movements, the control unit 7 initiates a closing event of the windows 4. After closing of the windows 4 the control unit then initiates the opening movement of the sliding door 1. It is similarly conceivable that a request to open the windows 4 is implemented only after registration of the sliding door position, or is blocked if the latter is opened. An opening of the windows 4 is advantageously blocked for a period of time until the sliding door is completely closed.

The combination represented in FIG. 2 of sliding door position and window module position is represented in a purely exemplary manner to illustrate some areas in which it is possible that injuries or damage to objects can occur. The positions represented would not thus occur in an extrinsic force-actuated opening movement, in particular if the method cited above is applied, since an extrinsic force-actuated opening of the sliding door 1 according to the invention is to be preceded by a closing of the window modules 4. A manual opening of the sliding door should, however, in terms of the invention preferably remain possible. The letters A, B and C identify three areas in which risks of injury or damage to objects exist that the invention seeks to minimise. In these areas in particular bodywork edges 8 and sliding door edges 9 can form shearing points or catch extrinsic objects protruding into the traversing range.

In the area A, in particular during an opening movement of the sliding door 1, an extrinsic object protruding into the traversing range of the sliding door 1 can be caught by a rearward sliding door edge 9′ or be trapped between the sliding door edge 9′ and the left-hand stationary edge 8′ of the window module 4″.

In the area B, in particular for an closing movement of the sliding door 1, an extrinsic object protruding into the traversing range of the sliding door 1 can be trapped between the left-hand edge 9″ of the window module 4″ and the right-hand stationary edge 8″ of the window module 4″. Furthermore, when the sliding door is completely opened the right-hand edge 9′″ of the window module 4′ located in the sliding door can also capture an extrinsic object in area B.

In area C, during a closing movement, an extrinsic object can be caught by the left-hand edge 9″ of the window module 4′ located in the sliding door. During an opening movement there exists a possibility of trapping between the stationary bodywork edge 8′″ and the right-hand edge 9′″ of the window module 4′ located in the sliding door.

What is claimed is:

1. A motor vehicle with
at least one sliding door (1) traversable along one side of the motor vehicle, actuated by means of an extrinsic force, which during a complete opening and closing movement travels through a traversing range, as well as
at least one window module (3) arranged in the sliding door (1) or in the stationary part of the vehicle bodywork (2) with one window (4) that can open and shut arranged at least partially within, or in the immediate vicinity of, the traversing range, wherein
the motor vehicle has a control means to avoid an unintended trapping of extrinsic objects or body parts,
characterised in that the control means is formed such that it registers the closing and/or opening state of the window (4) and depending upon the registered closing state of the window (4) can intervene in the movement of the sliding door (1) by interrupting, reducing, delaying or reversing the extrinsic force in the event of an endangered state, wherein the endangered state is defined in that extrinsic objects or body parts threaten to intrude into the traversing range because of an opening released by a window (4) located at least partially within the traversing range or in the immediate vicinity of the traversing range.

2. The motor vehicle according to claim 1,
characterised in that the control means are configured such that they permit a movement of the sliding door only when a window is closed.

3. The motor vehicle according to claim 1,
characterised in that the window (4) that can be opened and closed is driven by a motor and the control means have a means to register a critical resistance of the window and are configured such that in the event of closing the sliding door (1) they firstly initiate a closing movement of the window (4), and when blocking the closing movement of the window (4) as a result of detection of the critical resistance interrupt the drive of the sliding door (1), wherein the closing movement of the window (4) relative to the movement of the sliding door (1) has a form of advance movement such that the endangered state is prevented.

4. The motor vehicle according to claim 1,
characterised in that the control means are configured such that in the event of detection of an endangered state they can initiate the reversal of the movement of the sliding door (1).

5. The motor vehicle according to claim 1,
characterised in that the control means have at least one sensor (6, 6″) for the registration of the closing and/or opening state of the window (4).

6. The motor vehicle according to claim 1,
characterised in that the control means have at least one sensor (6, 6″) for the registration of the closing and/or opening state of the sliding door (1).

7. The motor vehicle according to claim 1,
characterised in that the control means comprise a control unit (7) for the control of the opening and closing events and for the processing of signals from sensors (6) to register the opening and closing states of the sliding door (1) and the windows (4).

8. The motor vehicle according to claim 1,
characterised in that the control means comprise blocking devices that completely or partially prevent the movement of the sliding door.

9. The motor vehicle according to claim 1,
characterised in that the control means are configured such that they permit a manual, not extrinsic force-actuated, opening or closing movement of the sliding door (1) independently of the endangered state.

10. The motor vehicle according to claim 1,
characterised in that the control means comprise delay devices, which delay the automatic movement of the sliding door up to a point in time at which a movement of the sliding door (1) is possible without risk.

11. The motor vehicle with a motor-driven window (4) according to claim 10,
characterised in that the control means have a means to store the opening state of the window (4) and are configured such that when there is a wish to close the sliding door (1) they firstly store the opening state of the window (4) and effect the closing of the window (4); after registration of the closing of the window (4) without complications they close the sliding door (1) and subsequently open the window (4) again to its original opening state.

12. The motor vehicle according to claim 5,
characterised in that monitoring devices are provided that prevent the opening of the windows (4) when the sliding door is open (1).

13. The motor vehicle according to claim 1,
characterised in that acoustic or optical signal transducers are provided that indicate an intervention of the control means into the sliding door movement or its prevention or delay by the control means.

14. The motor vehicle according to claim 1,
characterised in that the window module (3) is a sliding window module and/or a raising/lowering window module and/or a tilting window module and/or a swivelling window module.

15. The motor vehicle according to claim 5,
characterised in that the window module (3) has at least one sensor (6) for registering the closing and/or opening state of the window (4) in or on a guide rail of a movable window glass element and/or in a glass element seating of the window module (3) preferably arranged in or on the window frame of the window module (3).

16. The motor vehicle according to claim 5,
characterised in that the window module (3) has at least one sensor (6) for the registration of the closing and/or opening state in or on hinge elements of the window module (3), whose movements relative to one another are registered by the sensor (6).

17. A sliding door module, equipped for a motor vehicle according to claim 1, having control means
to avoid an unintended trapping of extrinsic objects or body parts,
characterised in that the control means are formed such that they register the closing and/or opening state of the window (4) and depending upon the registered closing and/or opening state of the window (4) can intervene in the movement of the sliding door (1) by interrupting, reducing, delaying or reversing the extrinsic force in the event of an endangered state, wherein
the endangered state is defined in that extrinsic objects or body parts threaten to intrude into the traversing range because of an opening released by a window (4) located at least partially within the traversing range or in the immediate vicinity of the traversing range.

18. A method for the closing or opening of an extrinsic force-actuated sliding door of a motor vehicle, which in a complete opening or closing movement travels through a traversing range, wherein the motor vehicle has at least one window module (3) arranged in the sliding door (1) or in the stationary part of the vehicle bodywork (2) with one window (4) that can open and close arranged at least partially within, or in the immediate vicinity, of the traversing range, as well as control means to avoid an unintended trapping of extrinsic objects or body parts, comprising the method steps
registration of the closing and/or opening state of the window (4) by the control means before and/or during the opening event,
establishment of the presence or the non-presence of an endangered state, wherein the endangered state is defined in that extrinsic objects or body parts threaten to intrude into the traversing range because of an opening released by a window (4) located at least partially within the traversing range
characterised by the method step
permission of the opening or closing movement of the sliding door (1) by the control means if an endangered state is not present, or intervention into the opening movement or closing movement of the sliding door (1) if an endangered state is present.

19. The method according to claim 18,
characterised by the further method step
delay of the opening or closing movement after registration of the opening or closing state of the windows (4) by the control means for a period of time until the windows in particular extrinsic force-actuated as a result of initiation by a control device (7), are completely or at least partially closed and the endangered state is no longer present.
